(19) United States
(12) Patent Application Publication
(10) Pub. No.: US 2025/0206319 A1
(43) Pub. Date: Jun. 26, 2025

(54) INATTENTIVENESS DETERMINATION DEVICE, INATTENTIVENESS DETERMINATION SYSTEM, AND INATTENTIVENESS DETERMINATION METHOD

(71) Applicants: TOYOTA JIDOSHA KABUSHIKI KAISHA, Toyota-shi (JP); DENSO CORPORATION, Kariya-City (JP)

(72) Inventor: Dai TONUMA, Toyota-shi (JP)

(73) Assignees: TOYOTA JIDOSHA KABUSHIKI KAISHA, Toyota-shi (JP); DENSO CORPORATION, Kariya-city (JP)

(21) Appl. No.: 18/977,219

(22) Filed: Dec. 11, 2024

(30) Foreign Application Priority Data
Dec. 22, 2023 (JP) 2023-216994

(51) Int. Cl. B60W 40/08; G06T 7/70; G06V 20/59; G06V 40/18

(52) U.S. Cl. CPC B60W 40/08; G06T 7/70; G06V 20/597; G06V 40/18; B60W 2040/0818; B60W 2420/403; B60W 2540/225; B60W 2540/229; G06T 2207/30201; G06T 2207/30268

(57) ABSTRACT

An inattentiveness determination device which determines whether or not a driver of a vehicle is inattentive, includes: a line-of-sight direction detection unit for detecting a line-of-sight direction of the driver; a terminal position detection unit for detecting a position of a mobile terminal in an interior of the vehicle based on an image acquired from an indoor camera for capturing an image of the interior of the vehicle; an inattentiveness determination unit for determining whether the driver is in an inattentive state based on whether or not the line-of-sight direction of the driver is within an inattentiveness determination region; and a region setting unit for setting a region in which the mobile terminal is located as the inattentiveness determination region, when there is the mobile terminal in the interior of the vehicle.

### FIELD

The present disclosure relates to an inattentiveness determination device, an inattentiveness determination system, and an inattentiveness determination method.

### BACKGROUND

Conventionally, a driver monitoring system is known that issues a warning to a driver when the driver operates a mobile terminal while the vehicle is driving (JP 2020-102252 A or the like). In particular, the system described in JP 2020-102252 A acquires an image captured by a camera of a mobile terminal via communication between the mobile terminal and a vehicle, and issues a warning when it is determined that the driver is looking at the mobile terminal based on the image.

### SUMMARY

When determining whether or not the driver is looking at the mobile terminal using an image captured by the camera of the mobile terminal, it is necessary to connect the mobile terminal owned by the driver and the vehicle so as to be able to communicate with each other. In this case, it is necessary to connect the mobile terminal and the vehicle each time the driver gets on and off or changes, which is troublesome. Further, when the driver does not perform the connection operation or when the mobile terminal does not support the connection with the vehicle, it is not possible to determine whether or not the driver is looking at the mobile terminal.

In view of the above problems, an object of the present disclosure is to be able to detect an inattentiveness of a driver by gazing at a mobile terminal, without connecting the vehicle and the mobile terminal.

The gist of the present disclosure is as follows.

(1) An inattentiveness determination device which determines whether or not a driver of a vehicle is inattentive, comprising:
a line-of-sight direction detection unit for detecting a line-of-sight direction of the driver;
a terminal position detection unit for detecting a position of a mobile terminal in an interior of the vehicle based on an image acquired from an indoor camera for capturing an image of the interior of the vehicle;
an inattentiveness determination unit for determining whether the driver is in an inattentive state based on whether or not the line-of-sight direction of the driver is within an inattentiveness determination region; and
a region setting unit for setting a region in which the mobile terminal is located as the inattentiveness determination region, when there is the mobile terminal in the interior of the vehicle.

(2) The inattentiveness determination device according to above (1), wherein the region setting unit sets, as the inattentiveness determination region, a region set in advance regardless of the position of the mobile terminal, in addition to the region in which the mobile terminal is located.

(3) An inattentiveness determination system comprising the inattentiveness determination device according to above (1) or (2), comprising:
a driver monitor camera which captures an image of a face of the driver; and
an indoor camera which captures an image of the interior of the vehicle, wherein
the line-of-sight direction detection unit detects the line-of-sight direction of the driver based on an image captured by the driver monitor camera, and
the indoor camera is arranged to capture an image of a region located in front of the driver.

(4) The inattentiveness determination system according to above (3), wherein the indoor camera is arranged so as to capture an image from a ceiling of the vehicle forwardly downwardly in the vehicle.

(5) A method for determining whether or not a driver of a vehicle is inattentive, including:
detecting a line-of-sight direction of the driver;

detecting a position of a mobile terminal in an interior of the vehicle based on an image acquired from an indoor camera for capturing an image of the interior of the vehicle;
determining whether or not the driver is in an inattentive state based on whether or not the line-of-sight direction of the driver is within an inattentiveness determination region; and
setting a region in which the mobile terminal is located as the inattentiveness determination region, when there is the mobile terminal in the interior of the vehicle.

### BRIEF DESCRIPTION OF DRAWINGS

FIG. 1 is a schematic block diagram illustrating a configuration of an inattentiveness determination system.

FIG. 2 is a schematic side view partially showing the inside of a vehicle equipped with an inattentiveness determination system.

FIG. 3 is a functional block diagram of a processor of an ECU.

FIGS. 4A and 4B are diagrams illustrating an inattentiveness determination region set by the region setting unit.

FIG. 5 is a flowchart illustrating a flow of region setting process for setting the inattentiveness determination region.

FIG. 6 is a flowchart illustrating a flow of an inattentiveness determination process for determining whether or not the driver is in an inattentive state.

### DESCRIPTION OF EMBODIMENTS

Hereinafter, embodiments will be described in detail with reference to the drawings. In the following description, the same reference numerals are given to the same constituent elements.

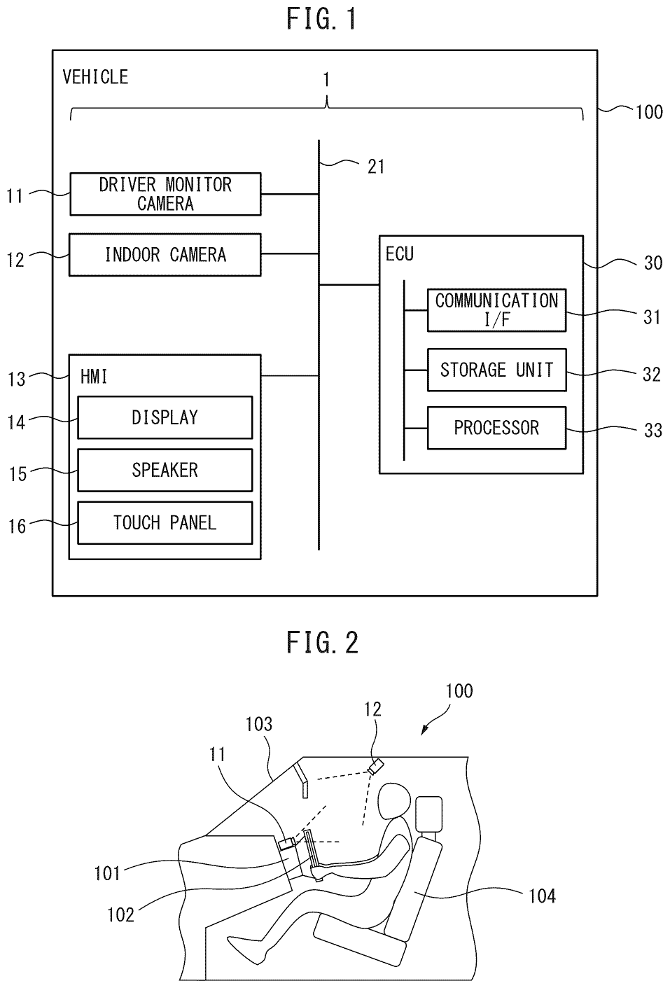

Referring to FIGS. 1 to 3, a configuration of an inattentiveness determination system 1 including an inattentiveness determination device according to one embodiment will be described. FIG. 1 is a schematic block diagram illustrating a configuration of an inattentiveness determination system 1. FIG. 2 is a schematic side view partially showing the inside of a vehicle 100 equipped with the inattentiveness determination system 1.

The inattentiveness determination system 1 is mounted on a vehicle 100 and determines whether or not the driver of the vehicle 100 is inattentive. As shown in FIG. 2, the vehicle 100 includes a steering wheel 102 attached via a steering column 101, a front window 103 disposed on a front side of the driver, and a driver seat 104 on which the driver is seated.

As illustrated in FIG. 1, in the present embodiment, the inattentiveness determination system 1 includes a driver monitor camera 11, an indoor camera 12, a human-machine interface (HMI) 13, and an electronic control unit (hereinafter, referred to as “ECU”) 30. The driver monitor camera 11, the indoor camera 12, the HMI 13, and the ECU 30 are communicably connected via, for example, the in-vehicle network 21. The in-vehicle network 21 is, for example, a network conforming to a standard such as CAN (Controller Area Network).

The driver monitor camera 11 captures an image of a face of the driver. In the present embodiment, the driver monitor camera 11 is provided at an upper portion of the steering column 101, and is arranged toward the driver so as to be able to capture an image of the driver, specifically, a face and a part of the upper body of the driver. The driver monitor camera 11 may be provided at a position different from the upper part of the steering column 101 as long as an image of the driver of the vehicle 100 can be captured. For example, the driver monitor camera 11 may be provided on a steering wheel 102, a room mirror, a meter panel, a meter hood, or the like of the vehicle 100.

The driver monitor camera 11 includes a camera and a projector. For example, the camera is a CMOS (Complementary Metal-Oxide-Semiconductor) camera or a CCD (Charge-Coupled Device) camera, and the projector is a LED (Light Emitting Diode). In addition, the projector is preferably in a near-infrared LED so that an image of the driver's face can be captured without causing discomfort to the driver even at low illuminance, such as at night, and the camera is also preferably capable of detecting near-infrared rays. For example, the projector may be two near-infrared LED located on either side of the camera. Further, the camera may be provided with a filter such as a visible light cut filter. The driver monitor camera 11 outputs images captured at predetermined intervals to the ECU 30 via the in-vehicle network 21.

The indoor camera 12 captures an image of the interior of the vehicle 100. In the present embodiment, the indoor camera 12 is provided on a ceiling of the vehicle 100 and is arranged so as to capture an image in a forward and downward direction of the vehicle 100. In particular, the indoor camera 12 is disposed above the seat 104 on which the driver is seated or above the rear side of the seat 104. As a result, the indoor camera 12 is arranged so as to capture an image of a region located in front of the driver. For example, the indoor camera 12 is disposed above the rear side of the driver seat 104, and is disposed so as to capture an image from the rear side of the driver toward the vehicle front side (toward the front window 103). In addition, in the present embodiment, the indoor camera 12 is arranged such that a space located between the driver's face and the front window 103 of the vehicle 100 is located within an angle of view. The indoor camera 12 may be arranged in any direction in the interior of the vehicle 100 as long as it can capture an image of an area located in front of the driver, particularly as long as a space located between the driver's face and the front window 103 is within an angle of view.

Similarly to the driver monitor camera, the indoor camera 12 includes a camera and a projector. Also in the indoor camera 12, the projector is preferably in a near-infrared LED, and the camera is preferably also capable of detecting near-infrared rays. The indoor cameras 12 also output images captured at predetermined intervals to the ECU 30 via the in-vehicle network 21. The indoor camera 12 may be a monocular camera or a stereo camera. When a stereo camera is used as the indoor camera 12, the indoor camera 12 can measure the relative position of an object in the interior of the vehicle 100.

The HMI 13 is an interface for inputting and outputting information between the driver or the occupant and the inattentiveness determined system 1. The HMI 13 includes an information providing device for providing various types of information to a driver or an occupant, and an input device for the driver or the occupant to perform an input operation.

Specifically, the HMI 13 includes, as an information providing device, a display 14 for displaying image information or character information. The display 14 is an example of a display device that displays an image. The display 14 may be any type of display device such as a liquid crystal display or an organic EL display. The display 14 is arranged so that at least the driver can see the screen. Accordingly, the display 14 is disposed, for example, on an instrument panel, a meter panel, or the like of the vehicle 100. The display 14 receives an image signal from the ECU 30 via the in-vehicle network 21, and displays an image in accordance with the image signal. Incidentally, the vehicle 100 may have a display equipment using other display methods such as a head-up display or the like, as the information providing device, in addition to or instead of the display 14.

The HMI 13 includes a speaker 15 as the information providing device. The speaker 15 is an example of a device that outputs sound. The speaker 15 receives an audio signal from the ECU 30 via the in-vehicle network 21, and outputs audio in accordance with the audio signal. The HMI 13 may include, as the information providing device, a device other than the display 14 and the speaker 15 that provides various kinds of information to the drivers or the occupants (for example, a vibrating device).

In addition, the HMI 13 includes a touch panel 16 as an inputting device. The touch panel 16 is an example of a device in which an input is performed by a driver or a passenger touching the device. The touch panel 16 outputs an operation signal to the ECU 30 via the in-vehicle network 21 when the driver or the occupant performs an operation by touching. The HMI 13 may include, as the input device, a device other than the touch panel 16 for the driver or the occupant to perform the input operation (for example, a button, a switch, or the like).

The ECU 30 functions as an inattentiveness determination device that determines whether or not the drivers of the vehicles 100 are inattentive. The ECU 30 also controls information provided by the information providing device of the HMI 13. Therefore, the ECU 30 controls the images displayed on the display 14 and the sound outputted from the speaker 15. As illustrated in FIG. 1, the ECU 30 includes a communication interface 31, a storage unit 32, and a processor 33.

The communication interface 31 is a circuit for connecting the ECU 30 to the in-vehicle network 21.

The storage unit 32 stores data. The storage unit 32 includes, for example, at least one of a volatile semiconductor memory, a nonvolatile semiconductor memory, a hard disk drive (HDD), and a solid state drive (SSD). The storage unit 32 stores a computer program executed by the processor 33 of the ECU 30. The storage unit 32 also stores data used in a computer program executed by the processor 33, such as data transmitted from the driver monitor camera 11 or the like.

The processor 33 comprises one or more CPU (Central Processing Unit) and its peripheral circuitry. The processor 33 may further include other arithmetic circuits such as a logical arithmetic unit or a numerical value arithmetic unit. The processor 33 executes a computer program stored in the storage unit 32.

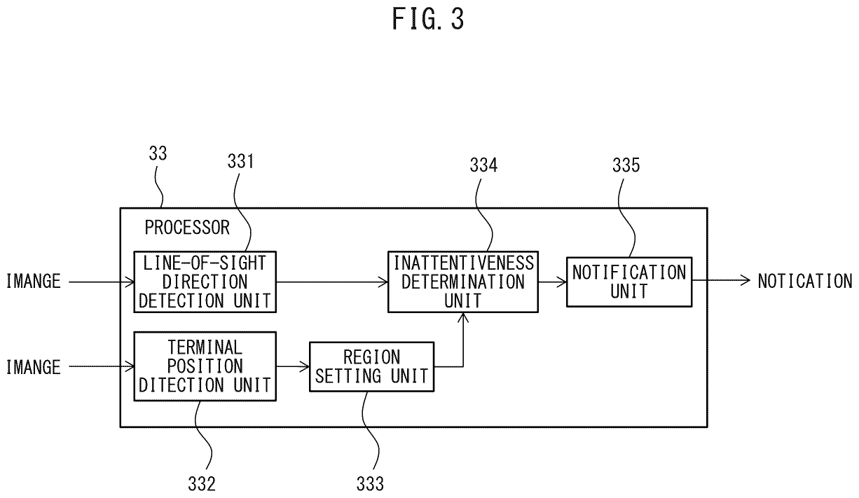

FIG. 3 is a functional diagram of the processor 33 of the ECU 30. As illustrated in FIG. 3, the processor 33 includes a line-of-sight direction detection unit 331, a terminal position detection unit 332, a region setting unit 333, an inattentiveness determination unit 334, and a notification unit 335.

The line-of-sight direction detection unit 331 detects the line-of-sight direction of the driver based on the image captured by the driver monitor camera 11. The line-of-sight direction is represented by a horizontal or vertical angle between the front-rear direction of the vehicle 100 and the line of sight of the driver. The line-of-sight direction detection unit 331 inputs information on the line-of-sight direction of the driver detected by the line-of-sight direction detection unit 331 to the inattentiveness determination unit 334.

Specifically, the line-of-sight direction detection unit 331 inputs the image acquired from the driver monitor camera 11 to a discriminator trained in advance so as to specify the positions of the pupil and the corneal reflection of the light source. Then, the line-of-sight direction detection unit 331 detects the line-of-sight direction based on the positional relationship between the specified pupil and the corneal reflection. As such a discriminator, for example, a convolutional neural network (CNN) is used which outputs the position of the pupil and the corneal reflection when facial images are inputted.

Alternatively, the line-of-sight direction detection unit 331 may input the image acquired from the driver monitor camera 11 to a discriminator that specifies the position of an inner corner and the iris in the driver's eye. In this case, the line-of-sight direction detection unit 331 detects the line-of-sight direction based on the identified positional relationship between the inner corner of the eye and the iris.

The terminal position detection unit 332 detects the presence or absence of the mobile terminal in the interior of the vehicle 100 and the position of the mobile terminal in the interior of the vehicle 100, based on the image acquired from the indoor camera 12. In particular, in the present embodiment, when a stereo camera is used as the indoor camera 12, the terminal position detection unit 332 detects the relative position of the mobile terminal with respect to the position of the eye. The terminal position detection unit 332 inputs the position information of the mobile terminal detected by the terminal position detection unit 332 to the region setting unit 333.

Specifically, the terminal position detection unit 332 inputs the image acquired from the indoor camera 12 to the discriminator trained in advance so as to specify the position of the mobile terminal. As such a discriminator, for example, a convolutional neural network (CNN) is used which, when an image of the interior of the vehicle 100 captured by the indoor camera 12 is inputted, outputs the presence or absence of a mobile terminal in the image and its position when there is a mobile terminal.

Further, the terminal position detection unit 332 detects, as a mobile terminal, a device that has a screen and is portable by a user. For example, the mobile terminal includes a smartphone, a tablet, a mobile game terminal, and the like.

The region setting unit 333 sets an inattentiveness determination region. The inattentiveness determination region is a region in which it is determined that the driver is in the inattentive state when the line-of-sight direction of the driver is within the inattentiveness determination region. In the present embodiment, the inattentiveness determination region is set as a region based on the position of the face of the driver, in particular, the position of the eye of the driver. Therefore, the inattentiveness determination region is represented as, for example, a range of angles in the up-down direction (vertical direction) and the left-right direction (horizontal direction) with respect to the position of the eye of the driver. The region setting unit 333 inputs the information of the inattentiveness determination region set by the region setting unit 333 to the inattentiveness determination unit 334.

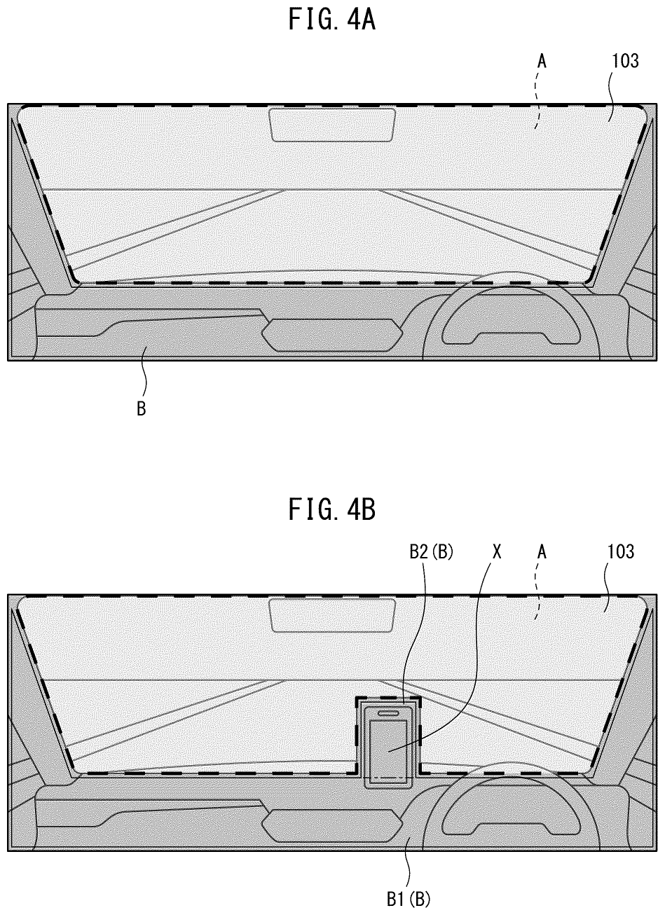

FIGS. 4A and 4B are diagrams illustrating an inattentiveness determination region set by the region setting unit 333. FIGS. 4A and 4B show a region in front of the interior of the vehicle 100. In particular, FIG. 4A illustrates a state in which the mobile terminal X is not present in a region in front of the interior of the vehicle 100, and FIG. 4B illustrates a state in which the mobile terminal X is present in a region in front of the interior of the vehicle 100.

During driving of the vehicle 100, the driver needs to be looking in front of the vehicle 100, so that the state in which the driver is looking in front of the vehicle 100 is basically not an inattentive state. On the other hand, while the vehicle 100 is driven by the driver, the driver does not need to be looking at a region other than the front of the vehicle 100, and therefore, the state in which the driver is looking at a direction other than the front of the vehicle 100 is basically an inattentive state.

Therefore, in the present embodiment, as illustrated in FIG. 4A, in a state in which the mobile terminal X is not present in the interior of the vehicle 100, the region setting unit 333 basically does not set a region in front of the vehicle 100, in particular, a region in which the front window 103 is located, as an inattentiveness determination region. In other words, the region setting unit 333 sets the region in which the front window 103 is located as a non-inattentiveness determination region (a light shaded region A surrounded by a broken line in the drawing) that is not an inattentiveness determination region. On the other hand, in a state where the mobile terminal X is not present in the interior of the vehicle 100, the region setting unit 333 basically sets a region other than the front of the vehicle 100, that is, a region other than the region where the front window 103 is located, to the inattentiveness determination region (a dark shaded region B surrounded by a solid line in the drawing). In particular, in the present embodiment, the region other than the region in which the front window 103 is located is a region that is set in advance in the inattentiveness determination region regardless of the presence or absence of the mobile terminal, and in the following, such area is also referred to as a basic region B1.

In the present embodiment, the entire region in which the front window 103 is located is set as the non-inattentiveness determination region. However, only a part of the region of the front window 103 (for example, a region located in front of the driver) may be set as the non-inattentiveness determination region. Alternatively, a region other than the region in which the front window 103 is located may be set as the non-inattentiveness determination region. Specifically, in addition to the region where the front window 103 is located, for example, the region where the side mirror, the rearview mirror, and the meter panel are located may also be set as the non-inattentiveness determination region. A region other than the region set as the non-inattentiveness determination region in this manner is set as the basic region B1.

Further, in the present embodiment, the basic area B1 is a fixed region set in advance. However, the basic region B1 may be a region that varies depending on the operating conditions. For example, when the direction indicator is not blinking, the basic area B1 may be set so as to include a region where a side mirror and a side window located on the side of the driver is located, but when the direction indicator is blinking, the basic area B1 may be set so as not to include a region where the side mirror or the side window on the side where the direction indicator is blinking is located.

In addition, in the present embodiment, as illustrated in FIG. 4B, when the mobile terminal X is in the interior of the vehicle 100, the region setting unit 333 sets a region where the mobile terminal X is located (the dark shaded region B2 surrounded by the solid line and the dashed-dotted line in FIG. 4B) as the inattentiveness determination region. Therefore, the region setting unit 333 sets the region B2 in which the mobile terminal X is located and the basic area B1, as the inattentiveness determination region B. On the other hand, in a state in which the mobile terminal X is in the interior of the vehicle 100, the region setting unit 333 sets, as the non-inattentiveness determination region A, a region in front of the vehicle 100, in particular, a region in which the region in which the mobile terminal X is located is excluded from the region in which the front window 103 is located.

Therefore, when the mobile terminal X is located in the interior of the vehicle 100 and the mobile terminal X is located at least partially in a region different from the basic area B1, the inattentiveness determination region B is enlarged as compared with a normal state in which the mobile terminal X is not located in the interior of the vehicle 100. On the other hand, even when the mobile terminal X is present in the interior of the vehicle 100, when the entire mobile terminal X is located in the basic region B1, the inattentiveness determination region B is set to the same region as in the normal case where the mobile terminal X is not present in the interior of the vehicle 100.

The inattentiveness determination unit 334 determines whether or not the driver is in the inattentive state, based on whether or not the line-of-sight direction of the driver is within the inattentiveness determination region B. Information regarding the line-of-sight direction of the driver is acquired from the line-of-sight direction detection unit 331. Further, the information on the inattentiveness determination region B is acquired from the region setting unit 333. In the present embodiment, when the line-of-sight direction detected by the line-of-sight direction detection unit 331 is within the inattentiveness determination region B for a predetermined reference time T (for example, several seconds), the inattentiveness determination unit 334 determines that the driver is in the inattentive state. On the other hand, when the line-of-sight direction of the driver detected by the line-of-sight direction detection unit 331 is within the inattentiveness determination region B but its duration is less than the reference time T, the inattentiveness determination unit 334 determines that the driver is not in the inattentive state. In addition, when the line-of-sight direction of the driver detected by the line-of-sight direction detection unit 331 is not in the inattentiveness determination region B, the inattentiveness determination unit 334 determines that the driver is not in the inattentive state. The inattentiveness determination unit 334 inputs information related to the determination result to the notification unit 335.

In the present embodiment, it is determined whether or not the driver is in the inattentive state, based on the same reference time T in all the regions in the inattentiveness determination region B. However, the reference time T may be set to a different time for each region in the inattentiveness determination region B. For example, the side mirror, the rearview mirror, the meter panel, and the like need to be temporarily visually recognized by the driver even during the operation of the vehicle 100. Therefore, the reference time T in the region where the side mirror, the rearview mirror, the meter panel, and the like are located may be set to a time longer than the reference time T in the other region (including the region where the mobile terminal X is located) in the inattentiveness determination region B.

The notification unit 335 notifies the driver when the inattentiveness determination unit 334 determines that the driver is in the inattentive state. For example, the notification unit 335 causes the display 14 to display that the driver is in an inattentive state. Alternatively, the notification unit 335 causes the speaker 15 to output, for example, a sound indicating that the driver is in an inattentive state.

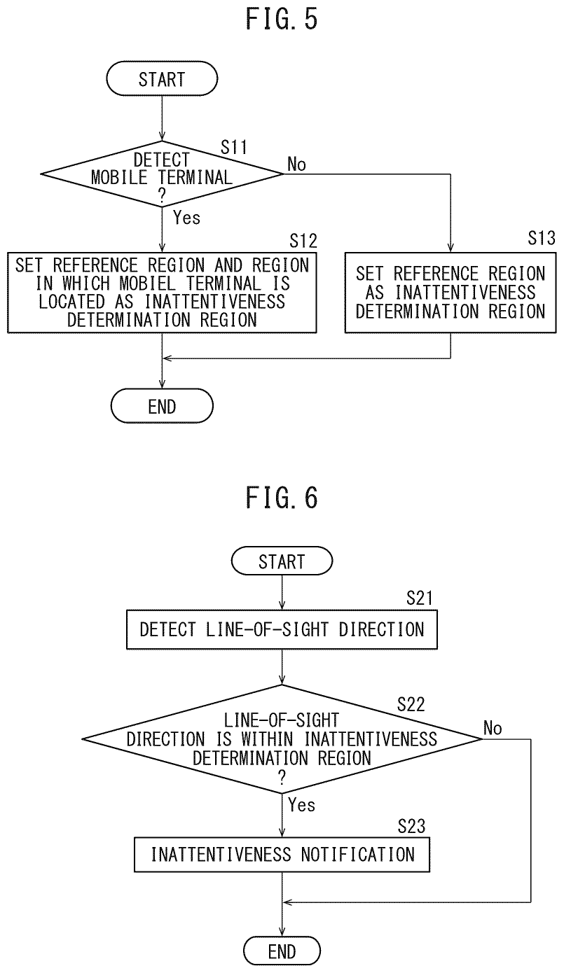

FIG. 5 is a flowchart illustrating a flow of region setting process for setting an inattentiveness determination region. The region setting process illustrated in FIG. 5 is executed by the processor 33 at regular time intervals.

In the region setting process, first, the region setting unit 333 determines whether or not the terminal position detection unit 332 has detected that there is a mobile terminal in the interior of the vehicle 100 (step S11).

When it is determined in step S11 that the presence of the mobile terminal in the interior of the vehicle 100 is detected, the region setting unit 333 sets, as an inattentiveness determination region, the region B2 in which the mobile terminal is located, in addition to the reference region B1 (step S12). Therefore, in the embodiment illustrated in FIGS. 4A and 4B, as illustrated in FIG. 4B, the reference region B1 and the region B2 in which the mobile terminal X is located are set as the inattentiveness determination region B. On the other hand, when it is determined in step S11 that the presence of the mobile terminal in the interior of the vehicle 100 is not detected, the region setting unit 333 sets the reference region B1 as the inattentiveness determination region (step S13). Therefore, in the example illustrated in FIGS. 4A and 4B, as illustrated in FIG. 4A, the entire region in which the front window 103 is located is set as the inattentiveness determination region B.

FIG. 6 is a flowchart illustrating a flow of an inattentiveness determination process for determining whether or not the driver is in an inattentive state. The inattentiveness determination process illustrated in FIG. 6 is executed by the processor 33 at regular time intervals.

In the inattentiveness determination process, first, the line-of-sight direction detection unit 331 acquires images transmitted from the driver monitor camera 11 to the ECU 30 and stored in the storage unit 32. Then, the line-of-sight direction detection unit 331 detects the line-of-sight direction of the driver based on the acquired images of the driver (step S21).

Next, the inattentiveness determination unit 334 determines whether or not the line-of-sight of the drivers detected in the step S21 is within the inattentiveness determination region (step S22). The inattentiveness determination unit 334 uses, as the inattentiveness determination region, a region set by the region setting process illustrated in FIG. 5, that is, a region set in the step S12 or S13 in FIG. 5.

When it is determined in the step S22 that the line-of-sight of the driver is not within the inattentiveness determination region, the inattentiveness determination process is terminated without notifying the driver. On the other hand, when it is determined in the step S22 that the line-of-sight direction of the driver is within the inattentiveness determination region, the notification unit 335 notifies the driver that the driver is in an inattentive state via the display 14 or the speaker 15 (step S23).

In the above-described embodiment, the position of the mobile terminal is detected based on the image captured by the indoor camera 12, and the inattentiveness determination region is set based on the detected position of the mobile terminal. Therefore, according to the above-described embodiment, it is possible to determine whether or not the driver is in an inattentive state in which the driver looks at the mobile terminal, without connecting the ECU 30 of the vehicle 100 and the mobile terminal.

While preferred embodiments according to the present disclosure have been described above, the present disclosure is not limited to these embodiments, and various modifications and changes can be made within the scope of the claims.

1. An inattentiveness determination device which determines whether or not a driver of a vehicle is inattentive, comprising a processor,
the processor is configured to:
detect a line-of-sight direction of the driver;
detect a position of a mobile terminal in an interior of the vehicle based on an image acquired from an indoor camera for capturing an image of the interior of the vehicle;
determine whether the driver is in an inattentive state based on whether or not the line-of-sight direction of the driver is within an inattentiveness determination region; and
set a region in which the mobile terminal is located as the inattentiveness determination region, when there is the mobile terminal in the interior of the vehicle.

2. The inattentiveness determination device according to claim 1, wherein the processor is configured to set, as the inattentiveness determination region, a region set in advance regardless of the position of the mobile terminal, in addition to the region in which the mobile terminal is located.

3. An inattentiveness determination system comprising the inattentiveness determination device according to claim 1, comprising:
a driver monitor camera which captures an image of a face of the driver; and
an indoor camera which captures an image of the interior of the vehicle, wherein
the processor is configured to detect the line-of-sight direction of the driver based on an image captured by the driver monitor camera, and
the indoor camera is arranged to capture an image of a region located in front of the driver.

4. The inattentiveness determination system according to claim 3, wherein the indoor camera is arranged so as to capture an image from a ceiling of the vehicle forwardly downwardly in the vehicle.

5. A method for determining whether or not a driver of a vehicle is inattentive, including:
detecting a line-of-sight direction of the driver;
detecting a position of a mobile terminal in an interior of the vehicle based on an image acquired from an indoor camera for capturing an image of the interior of the vehicle;
determining whether or not the driver is in an inattentive state based on whether or not the line-of-sight direction of the driver is within an inattentiveness determination region; and
setting a region in which the mobile terminal is located as the inattentiveness determination region, when there is the mobile terminal in the interior of the vehicle.

6. An inattentiveness determination system comprising the inattentiveness determination device according to claim 2, comprising:
a driver monitor camera which captures an image of a face of the driver; and
an indoor camera which captures an image of the interior of the vehicle, wherein
the processor is configured to detect the line-of-sight direction of the driver based on an image captured by the driver monitor camera, and
the indoor camera is arranged to capture an image of a region located in front of the driver.
